(19) United States
(12) Patent Application Publication
(10) Pub. No.: US 2024/0389088 A1
(43) Pub. Date: Nov. 21, 2024

(54) METHOD AND DEVICE FOR TRANSMITTING/RECEIVING A SYNCHRONIZATION SIGNAL BLOCK IN A SIDELINK COMMUNICATION

(71) Applicants: HYUNDAI MOTOR COMPANY, Seoul (KR); KIA CORPORATION, Seoul (KR); WONKWANG UNIVERSITY CENTER FOR INDUSTRY-ACADEMY COOPERATION, Iksan-si (KR)

(72) Inventors: Ui Hyun Hong, Hwaseong-si (KR); Gene Back Hahn, Hwaseong-si (KR); Hyuk Min Son, Seoul (KR)

(73) Assignees: HYUNDAI MOTOR COMPANY, Seoul (KR); KIA CORPORATION, Seoul (KR); WONKWANG UNIVERSITY CENTER FOR INDUSTRY-ACADEMY COOPERATION, Iksan-si (KR)

(21) Appl. No.: 18/786,060

(22) Filed: Jul. 26, 2024

Related U.S. Application Data
(63) Continuation of application No. PCT/KR2023/001186, filed on Jan. 26, 2023.

(30) Foreign Application Priority Data
Jan. 28, 2022 (KR) 10-2022-0013497

(51) Int. Cl. H04W 72/044; H04W 56/00; H04W 92/18

(52) U.S. Cl. CPC H04W 72/046; H04W 56/00; H04W 92/18

(57) ABSTRACT

The present disclosure provides a sidelink communication method. A method of use of transmitting user equipment (UE) may include steps in which: a transmitting UE checks whether data to be transmitted is present; a sidelink synchronization signal block (S-SSB) is determined based on whether the data to be transmitted is present; and the determined S-SSB is transmitted through respective transmission beams of the transmitting UE based on a beam sweeping method.

### CROSS-REFERENCE TO RELATED APPLICATIONS

This application is a continuation of International Application No. PCT/KR2023/001186 filed on Jan. 26, 2023, which claims priority to Korean Patent Application No. 10-2022-0013497 filed on Jan. 28, 2022, the entire contents of each of which are incorporated herein by reference.

### TECHNICAL FIELD

The present disclosure relates to a sidelink communication technique, and more particularly, to a technique for transmitting and receiving synchronization signal blocks for beam pairing in sidelink communication.

### BACKGROUND

A communication network (e.g., 5G communication network or 6G communication network) is being developed to provide enhanced communication services compared to the existing communication networks (e.g., long term evolution (LTE), LTE-Advanced (LTE-A), and the like). The 5G communication network (e.g., New Radio (NR) communication network) can support frequency bands both below 6 GHz and above 6 GHz. In other words, the 5G communication network can support both a frequency region 1 (FR1) and/or a frequency region 2 (FR2) band. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Methods for sidelink (SL) communication in the NR system's FR2 band has not yet been defined in the standards. In addition, in current SL communication, a synchronization acquisition process in an FR1 band may be performed by receiving synchronization signals from a base station, satellite, or terminal. In this case, a terminal transmitting the synchronization signal may transmit the synchronization signal, even if it is not a transmitting user equipment (TX-UE) intending to transmit data to a specific receiving UE (RX-UE).

When SL communication is in high-frequency bands including an FR2 band, data transmission and reception are possible with beam pairing between transmitting and receiving terminals. Thus, the initial beam pairing needs to be completed in the synchronization signal acquisition process. In other words, the RX-UE needs to complete synchronization and initial beam pairing through the synchronization signal of the TX-UE intending to transmit data to the RX-UE.

Therefore, development of synchronization acquisition and initial beam pairing methods between transmitting and receiving terminals is necessary to enable SL communication through beam pairing in both the FR2 and FR1 bands.

### SUMMARY

To resolve the above-described problems, the present disclosure provides a method and an apparatus for transmission and reception of synchronization signal blocks and beam pairing in sidelink communication.

A method of use for a transmitting user equipment (UE), according to an embodiment of the present disclosure for achieving the above-described objective, may include: identifying whether data to be transmitted by the transmitting UE exists; determining a sidelink synchronization signal block (S-SSB) based on whether the data to be transmitted exists; and transmitting the determined S-SSB through each of transmission beams of the transmitting UE based on a beam sweeping scheme.

A relationship between whether the data to be transmitted exists and the S-SSB may be preconfigured through higher layer signaling.

The higher layer signaling may include at least one of medium access control (MAC) control element (CE) or radio resource control (RRC) signaling.

The determined S-SSB may include information on a synchronization source of the transmitting UE and information indicating whether the synchronization source is in-coverage or out-of-coverage.

The determined S-SSB may include information on an identifier of a UE that is to receive the data to be transmitted.

The method may further include: identifying the number of times the determined S-SSB needs to be transmitted within a transmission period of the S-SSB and the number of the transmission beams; and in response to the number of the transmission beams being smaller than the number of times the determined S-SSB needs to be transmitted, transmitting the determined S-SSB by repeating use of at least one of the transmission beams.

The number of times the determined S-SSB needs to be transmitted may be preconfigured through higher layer signaling.

The number of repeated transmissions and a repeated transmission scheme for the determined S-SSB may be preconfigured using at least one of MAC CE, RRC signaling, system information block (SIB), or master information block (MIB).

A transmitting user equipment (UE), according to an embodiment of the present disclosure for achieving the above-described objective, may include a processor. The processor may cause the transmitting UE to: identify whether data to be transmitted exists; determine a sidelink synchronization signal block (S-SSB) based on whether the data to be transmitted exists; and transmit the determined S-SSB through each of transmission beams of the transmitting UE based on a beam sweeping scheme.

A relationship between whether the data to be transmitted exists and the S-SSB may be preconfigured through higher layer signaling.

The higher layer signaling may include at least one of medium access control (MAC) control element (CE) or radio resource control (RRC) signaling.

The determined S-SSB may include information on a synchronization source of the transmitting UE and information indicating whether the synchronization source is in-coverage or out-of-coverage.

The determined S-SSB may include information on an identifier of a UE that is to receive the data to be transmitted.

The processor may further cause the transmitting UE to: identify the number of times the determined S-SSB needs to be transmitted within a transmission period of the S-SSB and the number of the transmission beams; and in response to the number of the transmission beams being smaller than the number of times the determined S-SSB needs to be transmitted, transmit the determined S-SSB by repeating use of at least one of the transmission beams.

The number of times the determined S-SSB needs to be transmitted may be preconfigured through higher layer signaling.

The number of repeated transmissions and a repeated transmission scheme for the determined S-SSB may be preconfigured using at least one of MAC CE, RRC signaling, system information block (SIB), or master information block (MIB).

A method of a receiving user equipment (UE), according to an embodiment of the present disclosure for achieving the above-described objective, may include: receiving, through higher layer signaling, configuration information of a relationship between whether data to be transmitted exists and a sidelink synchronization signal block (S-SSB); receiving, from a transmitting UE, an S-SSB including information on whether data to be transmitted exists, in a transmission period of the S-SSB; and identifying whether the data to be transmitted by the transmitting UE exists based on the received S-SSB.

The method may further include: in response to identifying that the data to be transmitted by the transmitting UE exists, starting an initial beam pairing procedure with the transmitting UE.

The method may further include: in response to identifying that the data to be transmitted by the transmitting UE exists, comparing an identifier of a destination UE included in the received S-SSB and an identifier of the receiving UE; and in response to the identifier of the destination UE being equal to the identifier of the receiving UE, starting an initial beam pairing procedure with the transmitting UE.

The higher layer signaling may include at least one of medium access control (MAC) control element (CE) or radio resource control (RRC) signaling.

According to an embodiment of the present disclosure, smooth sidelink communication can be achieved through synchronization acquisition and beam pairing.

Furthermore, according to an embodiment of the present disclosure, during synchronization acquisition in sidelink communication, it is possible to confirm whether a transmitting terminal intends to transmit data and/or whether data to be transmitted by the transmitting terminal is for a receiving terminal. Consequently, power consumption at the receiving terminal can be reduced.

### BRIEF DESCRIPTION OF THE DRAWINGS

FIG. 1 is a conceptual diagram illustrating scenarios of Vehicle-to-Everything (V2X) communications.

FIG. 2 is a conceptual diagram illustrating an embodiment of a communication system.

FIG. 3 is a conceptual diagram illustrating an embodiment of a communication node constituting a communication system.

FIG. 4 is a block diagram illustrating an embodiment of communication nodes performing communication.

FIG. 5A is a block diagram illustrating an embodiment of a transmission path.

FIG. 5B is a block diagram illustrating an embodiment of a reception path.

FIG. 6 is a block diagram illustrating an embodiment of a user plane protocol stack of a UE performing sidelink communication.

FIG. 7 is a block diagram illustrating an embodiment of a control plane protocol stack of a UE performing sidelink communication.

FIG. 8 is a block diagram illustrating an embodiment of a control plane protocol stack of a UE performing sidelink communication.

FIG. 9 is a conceptual diagram for describing a structure of a sidelink synchronization signal block in the 5G NR mobile communication system.

FIG. 10A is a conceptual diagram illustrating an example for repeated S-SSB transmission when 8 transmissions are configured within an S-SSB transmission period and a synchronization signal transmitting terminal can use 4 beams.

FIG. 10B is a conceptual diagram illustrating another example for repeated S-SSB transmission when 8 transmissions are configured within an S-SSB transmission period and a synchronization signal transmitting terminal can use 4 beams.

FIG. 11A is a signal flow diagram for a case where an initial beam pairing procedure is not performed based on S-SSBs according to an embodiment of the present disclosure.

FIG. 11B is a signal flow diagram an initial beam pairing procedure is performed based on S-SSBs according to an embodiment of the present disclosure.

FIG. 12A is a signal flow diagram for a case where an initial beam pairing procedure is not performed based on S-SSBs according to another embodiment of the present disclosure.

FIG. 12B is a signal flow diagram an initial beam pairing procedure is performed based on S-SSBs according to another embodiment of the present disclosure.

### DETAILED DESCRIPTION

Since the present disclosure may be variously modified and have several forms, specific embodiments are shown in the accompanying drawings and are described in detail in the detailed description. It should be understood, however, that it is not intended to limit the present disclosure to the specific embodiments. On the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, the term ‘(re)transmission’ may refer to ‘transmission’, ‘retransmission’, or ‘transmission and retransmission.’ The term ‘(re)configuration’ may refer to ‘configuration’, ‘reconfiguration’, or ‘configuration and reconfiguration.’ The term ‘(re)connection’ may refer to ‘connection’, ‘reconnection’, or ‘connection and reconnection.’ The term ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. When it is mentioned that a certain component is “directly coupled with” or “directly connected with” another component, it should be understood that a further component is not disposed therebetween.

The terms used in the present disclosure are only used to describe specific embodiments and should not limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists. However, it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings consistent with contextual meanings in the art. In this description, unless defined clearly, terms are not necessarily construed as having formal meanings.

When a component, processor, controller, device, element, apparatus, equipment or the like of the present disclosure is described as having a purpose or performing an operation, function, or the like, the component, processor, controller, device, element, apparatus, equipment or the like should be considered herein as being “configured to” meet that purpose or to perform that operation or function.

Hereinafter, embodiments of the present disclosure are described in detail with reference to the accompanying drawings. In describing the disclosure, to facilitate the entire understanding of the disclosure, like numbers refer to like elements throughout the description of the figures and repetitive descriptions thereof have been omitted. The operations according to the embodiments described explicitly in the present disclosure, as well as combinations of the embodiments, extensions of the embodiments, and/or variations of the embodiments, may be performed. Some operations may be omitted, and a sequence of operations may be altered.

Even when a method (e.g., transmission or reception of a signal) to be performed at a first communication node among communication nodes is described in embodiments, a corresponding second communication node may perform a method (e.g., reception or transmission of the signal) corresponding to the method performed at the first communication node. In other words, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. In the present disclosure, ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which embodiments are applied is not limited to that described below, and the embodiments may be applied to various communication networks (e.g., 4G communication networks, 5G communication networks, and/or 6G communication networks). In the present disclosure, ‘communication network’ may be used interchangeably with a term ‘communication system’.

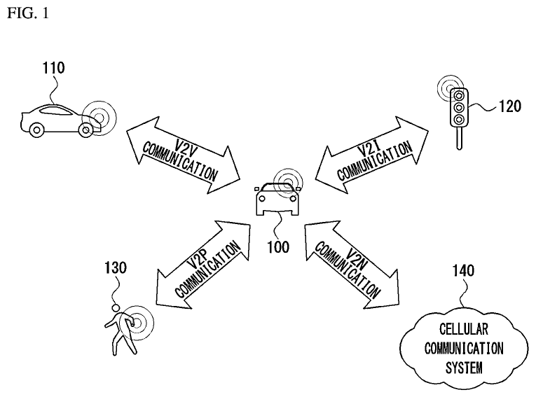

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications.’ The communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink (SL) communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3rd Generation Partnership Project (3GPP) standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

The communication system 140 supporting the V2X communications may be configured as follows.

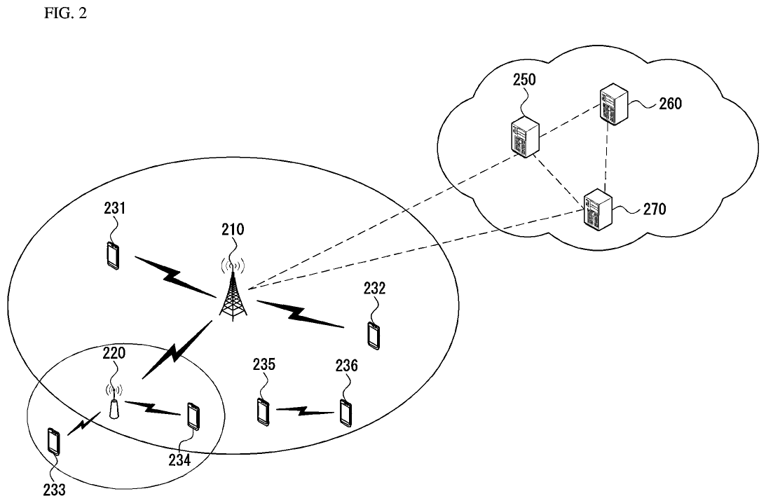

FIG. 2 is a conceptual diagram illustrating an embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, and the like) may be configured, and the V2X communications may be supported through the V2X network slices configured in the core network.

The communication nodes (e.g., base station, relay, UE, S-GW, P-GW, MME, UPF, SMF, AMF, and the like) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, and the like) constituting the communication system may be configured as follows.

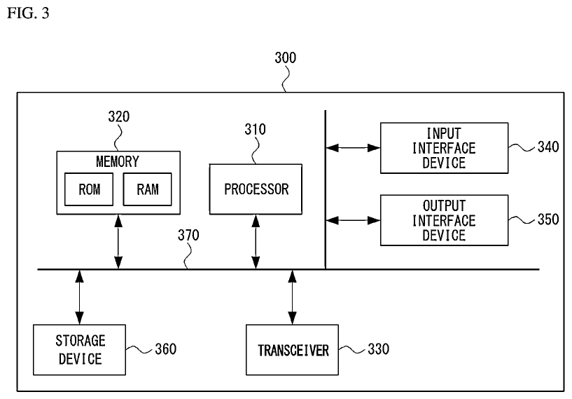

FIG. 3 is a conceptual diagram illustrating an embodiment of a communication node constituting a communication system.

As shown in FIG. 3, a communication node 300 may include at least one processor 310, a memory 320, and a transceiver 330 connected to a network for performing communications. Also, the communication node 300 may further include an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with embodiments of the present disclosure are performed. Each of the memory 320 and the storage device 360 may include at least one of a volatile storage medium and a non-volatile storage medium. For example, the memory 320 may include at least one of read-only memory (ROM) and random access memory (RAM).

Referring again to FIG. 2, in the communication system, the base station 210 may form a macro cell or a small cell and may be connected to the core network via an ideal backhaul or a non-ideal backhaul. The base station 210 may transmit signals received from the core network to the UEs 231 through 236 and the relay 220 and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. In other words, the relay 220 may transmit signals received from the base station 210 to the UEs 233 and 234 and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. In other words, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, and the like), coordinated multipoint (CoMP) communication technologies, carrier aggregation (CA) communication technologies, unlicensed band communication technologies (e.g., Licensed Assisted Access (LAA), enhanced LAA (eLAA), and the like), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

The base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

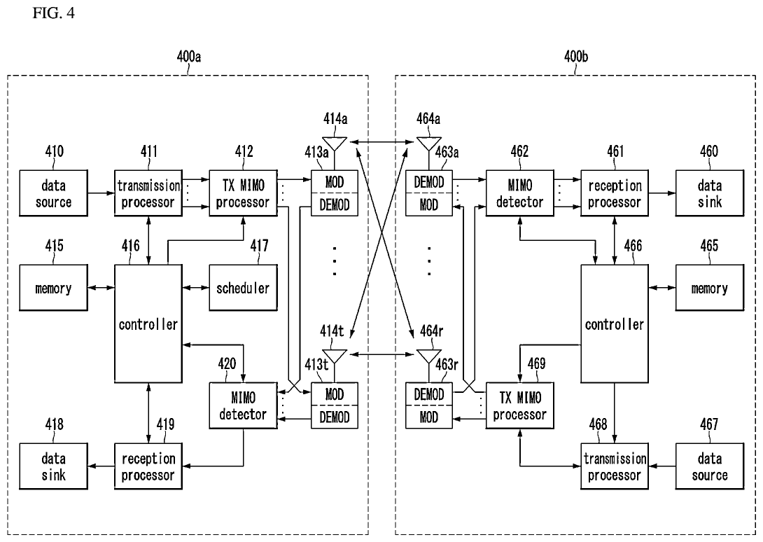

Communication nodes that perform communications in the communication network may be configured as follows. A communication node shown in FIG. 4 may be a specific embodiment of the communication node shown in FIG. 3.

FIG. 4 is a block diagram illustrating an embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, and the like) on the data. The transmission processor 411 may generate control symbol(s) by performing processing operations (e.g., encoding operation, symbol mapping operation, and the like) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream and may generate signals by performing additional processing operations (e.g., analog conversion operations, amplification operation, filtering operation, up-conversion operation, and the like) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, and the like) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, and the like) on the symbols. An output of the reception processor 461 may be provided to a data sink 460 and a controller 466. For example, the data may be provided to the data sink 460 and the control information may be provided to the controller 466.

The second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, and the like) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3 and may be used to perform methods described in the present disclosure.

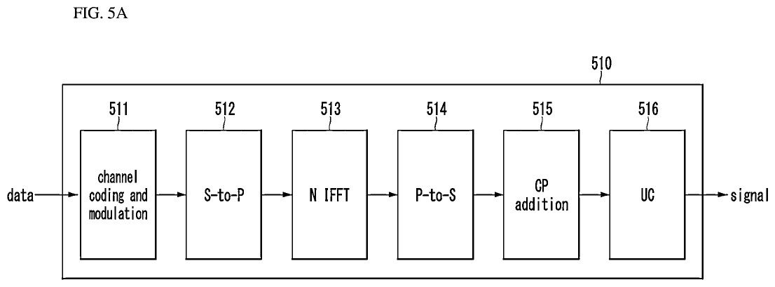

FIG. 5A is a block diagram illustrating an embodiment of a transmission path. FIG. 5B is a block diagram illustrating an embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point fast Fourier transform (FFT) block 524, a P-to-S block 525, and a channel decoding and demodulation block 526. Further, N may be a natural number.

In the transmission path 510, information bits may be input to the channel coding and modulation block 511. The channel coding and modulation block 511 may perform a coding operation (e.g., low-density parity check (LDPC) coding operation, polar coding operation, and the like) and a modulation operation (e.g., Quadrature Phase Shift Keying (OPSK), Quadrature Amplitude Modulation (QAM), and the like) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of |
| | base station 210 | other base station |

A user plane protocol stack of the UEs (e.g., the UEs 235 and 236) performing sidelink communications may be configured as follows.

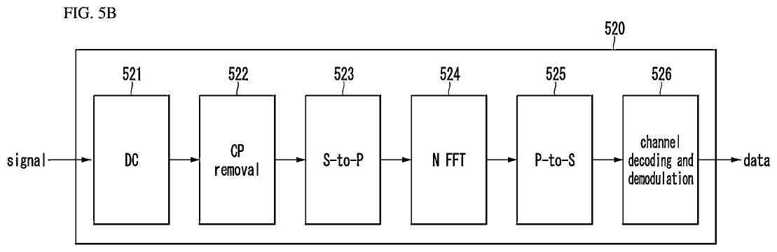

FIG. 6 is a block diagram illustrating an embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may include a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

A control plane protocol stack of the UEs (e.g., the UEs 235 and 236) performing sidelink communications may be configured as follows.

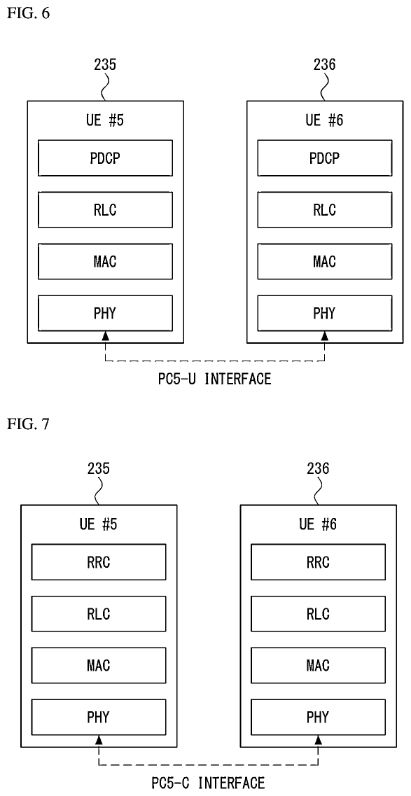

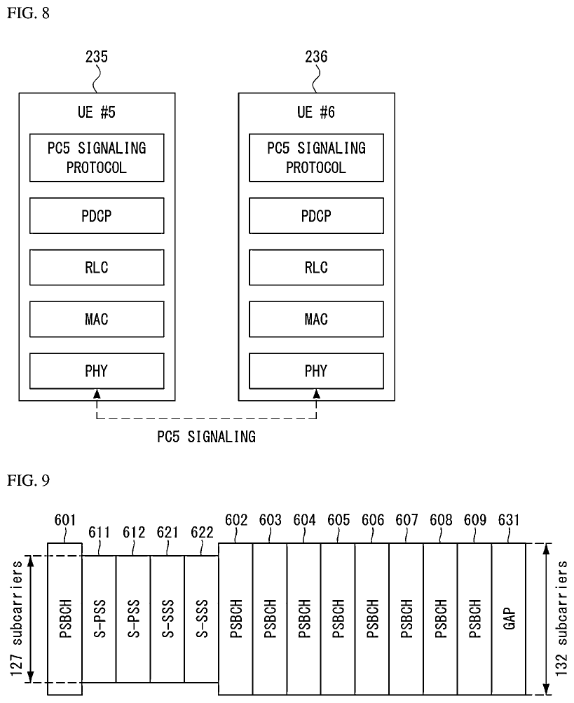

FIG. 7 is a block diagram illustrating an embodiment of a control plane protocol stack of a UE performing sidelink communication. FIG. 8 is a block diagram illustrating an embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the Ues 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

A sidelink transmission mode (TM) may be classified into sidelink TMs 1 to 4 as shown below in Table 2.

TABLE 2

| Sidelink | |
|---|---|
| TM | Description |
| 1 | Transmission using resources scheduled by base station |
| 2 | UE autonomous transmission without scheduling of base |
| | station |
| 3 | Transmission using resources scheduled by base station |
| | in V2X communications |
| 4 | UE autonomous transmission without scheduling of base |
| | station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods are described. Even when a method (e.g., transmission or reception of a signal) to be performed at a first communication node among communication nodes is described, a corresponding second communication node may perform a method (e.g., reception or transmission of the signal) corresponding to the method performed at the first communication node. In other words, when an operation of a UE #1 (e.g., vehicle #1) is described, a UE #2 (e.g., vehicle #2) corresponding thereto may perform an operation corresponding to the operation of the UE #1. When an operation of the UE #2 is described, the corresponding UE #1 may perform an operation corresponding to the operation of the UE #2. In embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

According to the agreements reached at the NR standard meetings, the following contents have been agreed upon.

### [Agreement 1]

A sidelink-SSB (S-SSB) structure for a normal CP (NCP) has been determined. An S-SSB structure for an extended CP (ECP) has the same structure, except that the number of PSBCH symbols after S-SSS is 6.

### [Agreement 2]

An S-SSB periodicity of 160 ms is supported for all subcarrier spacings (SCSs).
The number of S-SSB transmissions within one S-SSB period is (pre)configurable.
   For FR1:

The number of transmissions may be (pre)configured as {1} for 15 kHz SCS, {1, 2} for 30 kHz SCS, and {1, 2, 4} for 60 kHz SCS.
For FR2:

The number of transmissions may be (pre)configured as {1, 2, 4, 8, 16, 32} for 60 kHz SCS, and {1, 2, 4, 8, 16, 32, 64} for 120 kHz SCS.

### [Agreement 3]

672 SL-SSIDs are divided into two sets to represent different synchronization priorities according to a similar approach as in LTE-V2X.
id_net configuration {0, 1, . . . , 335}
id_oon configuration {336, 337, 338, . . . , 671}
The usage of 0 is the same as 0 in LTE.
The usage of 336 is the same as 168 in LTE.
The usage of 337 is the same as 169 in LTE.

### [Agreement 4]

S-SSB transmission triggering in NR V2X reuses the same mechanism as in LTE V2X.

### [Agreement 5]

S-SSBs within a period of 160 ms may be distributed at equal intervals using (pre)configured parameters below.
Offset from a start of the S-SSB period to the first S-SSB
Spacing between adjacent S-SSBs

### [S-SSB Beam Sweeping Scheme]

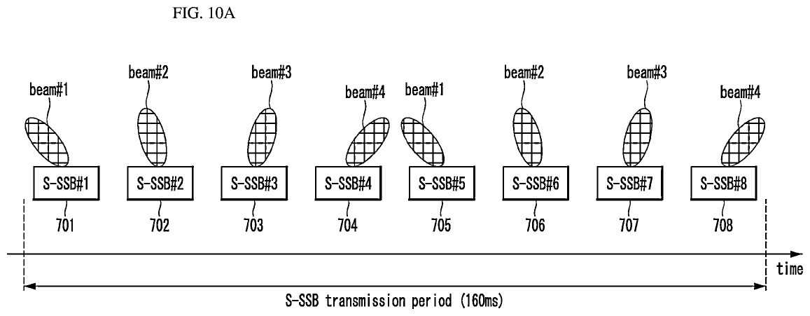

FIG. 9 is a conceptual diagram for describing a structure of a sidelink synchronization signal block in the 5G NR mobile communication system.

A sidelink synchronization signal block (S-SSB) illustrated in FIG. 9 exemplifies a case of normal cyclic prefix (normal CP). In FIG. 9, the horizontal axis may be a time axis, and the vertical axis may be a frequency axis. In the NR system, an SCS varies depending on a numerology, and may have a normal CP or extended CP based on a delay spreading. One slot constituting a sidelink synchronization signal block with a normal CP may be composed of 14 OFDM symbols as illustrated in FIG. 9.

As shown in FIG. 9, in the time domain, a physical sidelink broadcast channel (PSBCH) is transmitted in the first symbol 601, a sidelink primary synchronization signal (S-PSS) is transmitted in the second symbol 612 and third symbol 613, and a sidelink secondary synchronization signal (S-SSS) is transmitted in the fourth symbol 621 and fifth symbol 622. Then, the PSBCH is transmitted in 8 symbols 602 to 609. The last symbol 631 is a gap symbol (GAP), and usually referred to as a guard. No data is transmitted in the last symbol 631.

Although not illustrated in FIG. 9, in an extended CP case where one slot is configured with 12 OFDM symbols, an S-SSB may include 2 S-PSS symbols, 2 S-SSS symbols, and 7 PSBCH symbols. In other words, in the extended CP case, there are two fewer PSBCH symbols than in the normal CP case. In both cases of the normal CP and the extended CP, no signal is transmitted in the last symbol of the slot.

In addition, as illustrated in FIG. 9, the PSBCH symbols 601 and 602 to 609 may be configured with 132 subcarriers, and the S-PSS symbols 611 and 612 and the S-SSS symbols 621 and 622 may be configured with 127 subcarriers. Therefore, the S-SSB is transmitted through 11 resource blocks (RB) within a sidelink bandwidth part (SL BWP).

When the S-PSS, S-SSS, and PSBCH are transmitted based on the S-SSB structure, periodicity (i.e., 160 ms), and number of S-SSBs that can be transmitted within one period, which are defined in the current standards, an S-SSB transmitting entity (e.g., synchronization signal transmitting terminal) may transmit S-SSBs in a beam sweeping scheme at a high frequency band such as FR2.

The synchronization signal transmitting terminal that transmits S-SSBs by sweeping a plurality of beams in a high frequency band may transmit a signal having the S-SSB structure illustrated in FIG. 9 through each beam within the 160 ms period, which is an S-SSB transmission period. For example, if S-SSB is configured to be transmitted 8 times during the 160 ms period, the synchronization signal transmitting terminal may transmit the S-SSB 8 times using available beams within the S-SSB period.

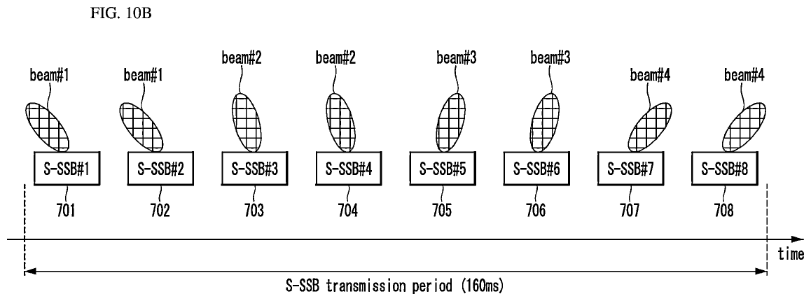

In this case, a case may occur in which the number of beams that the synchronization signal transmitting terminal can form is less than the number of S-SSBs that need to be transmitted. For example, if the total number of beams available to the synchronization signal transmitting terminal is 4, each S-SSB may be repeatedly transmitted twice with 4 different beams. This case is described with reference to FIGS. 10A and 10B.

FIG. 10A is a conceptual diagram illustrating an example for repeated S-SSB transmission when 8 transmissions are configured within an S-SSB transmission period and a synchronization signal transmitting terminal can use 4 beams. FIG. 10B is a conceptual diagram illustrating another example for repeated S-SSB transmission when 8 transmissions are configured within an S-SSB transmission period and a synchronization signal transmitting terminal can use 4 beams.

FIG. 10A exemplifies a case where the S-SSB transmission periodicity is set to 160 ms, and S-SSB #1 701 to S-SSB #8 708 are configured at predetermined time intervals within the S-SSB transmission period. The S-SSB #1 701 may be a time for transmitting the first S-SSB, the S-SSB #2 702 may be a time for transmitting the second S-SSB, the S-SSB #3 703 may be a time for transmitting the third S-SSB, the S-SSB #4 704 may be a time for transmitting the fourth S-SSB, the S-SSB #5 705 may be a time for transmitting the fifth S-SSB, the S-SSB #6 706 may be a time for transmitting the sixth S-SSB, the S-SSB #7 707 may be a time for transmitting the seventh S-SSB, and the S-SSB #8 708 may be a time for transmitting the eighth S-SSB.

In addition, when the synchronization signal transmitting terminal can form four beams, if the respective beams are referred to as beam #1, beam #2, beam #3, and beam #4, the beams #1 to #4 may be beams formed in different directions. In other words, the beam #1, beam #2, beam #3, and beam #4 may respectively refer to directions of the beams.

Therefore, when the synchronization signal transmitting terminal transmits the S-SSB eight times using four beams within the S-SSB transmission period, the S-SSBs may be transmitted as illustrated in FIG. 10A. Specifically, referring to FIG. 10A, the synchronization signal transmitting terminal may transmit the S-SSB #1 701 and S-SSB #5 705 through the beam #1. In other words, the synchronization signal transmitting terminal may transmit the S-SSB #1 701 and S-SSB #5 705 using the beam #1 in the same direction. The synchronization signal transmitting terminal may transmit the S-SSB #2 702 and S-SSB #6 706 through the beam #2. In other words, the synchronization signal transmitting terminal may transmit the S-SSB #2 702 and S-SSB #6 706 using the beam #2 in the same direction. In addition, the synchronization signal transmitting terminal may transmit the S-SSB #3 703 and S-SSB #7 707 through the beam #3. In other words, the synchronization signal transmitting terminal may transmit the S-SSB #3 703 and S-SSB #7 707 using the beam #3 in the same direction. In addition, the synchronization signal transmitting terminal may transmit the S-SSB #4 704 and S-SSB #8 708 through the beam #4. In other words, the synchronization signal transmitting terminal may transmit the S-SSB #4 704 and S-SSB #8 708 using the beam #4 in the same direction.

Describing the operations illustrated in FIG. 10A as a whole, the synchronization signal transmitting terminal may transmit the S-SSBs while sequentially changing the respective beams that can be configured within the S-SSB transmission period, and then start again from the first transmitted beam after transmitting eight S-SSBs. In other words, as shown in FIG. 10A, the S-SSBs can be transmitted sequentially first through four different beams, and then the four beams may be repeatedly transmitted in the same order.

FIG. 10B also exemplifies a case where the S-SSB transmission periodicity is set to 160 ms and S-SSB #1 701 to S-SSB #8 708 are configured at predetermined time intervals within the S-SSB transmission period, as in the case of FIG. 10A. The S-SSB #1 701 to S-SSB #8 708 may be respective times for transmitting the corresponding S-SSBs within the S-SSB transmission period.

In addition, as described in FIG. 10A, it may be assumed that the synchronization signal transmitting terminal can form four beams, beam #1, beam #2, beam #3, and beam #4, and the beam #1, beam #2, beam #3, and beam #4 respectively refer to directions of the beams.

The case of FIG. 10B may be another case in which the synchronization signal transmitting terminal transmits S-SSB 8 times using 4 beams within the S-SSB transmission period, which is different from the case of FIG. 10A. Specifically, referring to FIG. 10B, the synchronization signal transmitting terminal may transmit the S-SSB #1 701 and S-SSB #2 702 through the beam #1. In other words, the synchronization signal transmitting terminal may transmit the S-SSB #1 701 and S-SSB #2 702 using the beam #1 in the same direction. The synchronization signal transmitting terminal may transmit the S-SSB #3 703 and S-SSB #4 704 through the beam #2. In other words, the synchronization signal transmitting terminal may transmit the S-SSB #3 703 and S-SSB #4 704 using the beam #2 in the same direction. In addition, the synchronization signal transmitting terminal may transmit the S-SSB #5 705 and S-SSB #6 706 through the beam #3. In other words, the synchronization signal transmitting terminal may transmit the S-SSB #5 705 and S-SSB #6 706 using the beam #3 in the same direction. In addition, the synchronization signal transmitting terminal may transmit the S-SSB #7 707 and S-SSB #8 708 through the beam #4. In other words, the synchronization signal transmitting terminal may transmit the S-SSB #7 707 and the S-SSB #8 708 using the beam #4 in the same direction.

Describing the operations illustrated in FIG. 10B as a whole, the synchronization signal transmitting terminal may transmit the S-SSB twice per beam using beams that can be configured within the S-SSB transmission period. In other words, in the case of FIG. 10B, the S-SSB may be repeatedly transmitted through one beam, and then the S-SSB may be repeatedly transmitted twice through another beam.

In the case of FIGS. 10A and 10B described above, the number of repetitions of transmission with the same beam may be set and operated. For example, a case where the number of repetitions consecutively transmitted through the same beam is set to 1 may correspond to the case shown in FIG. 10A. A case where the number of repetitions consecutively transmitted through the same beam is set to 2 may correspond to the case shown in FIG. 10B.

The scheme illustrated in FIG. 10A may be necessary when the beam transmitting the S-SSB is designed to be sufficiently narrow, taking into account the distance between the transmitting and receiving terminals and the channel environment. This allows receiving terminals corresponding to a specific beam direction to receive, detect, and decode a single S-SSB. In this case, the transmitting terminal can minimize latency by rapidly sweeping the beams to transmit the S-SSBs. The scheme illustrated in FIG. 10A may be applied when a detection probability of S-SSB or a decoding success probability of PSBCH is above a certain level, or when a detection failure probability of S-SSB or a decoding failure probability of PSBCH is below a certain level.

Also, the scheme illustrated in FIG. 10B may be necessary when the beam transmitting the S-SSB is not designed to be sufficiently narrow, taking into account the distance between the transmitting and receiving terminals and the channel environment. In this case, the receiving terminals corresponding to a specific beam direction may not be able to receive, detect, and decode a single S-SSB. The synchronization signal transmitting terminal rapidly and repeatedly transmits the S-SSB using the same beam, so that the receiving terminals can increase a probability of successful reception, detection, and decoding of the S-SSBs. The scheme illustrated in FIG. 10B may be applied when a detection probability of S-SSB or a decoding success probability of PSBCH is below a certain level, or when a detection failure probability of S-SSB or a decoding failure probability of PSBCH is above a certain level. In addition, compared to the scheme illustrated in FIG. 10A, this scheme can minimize latency by increasing a reception probability of S-SSBs. Alternatively, the scheme in FIG. 10B may be utilized to extend a service coverage or communication range of the transmitting terminal.

If one of the schemes illustrated FIGS. 10A and 10B can be selected and operated by configuration for SL communication, the number of consecutive repeated transmissions may be set to the receiving terminal through higher layer signaling, such as a MAC control element (CE), RRC signaling, sidelink-system information block (S-SIB), and sidelink-master information block (S-MIB), at the time of S-SSB transmission or before. In other words, one of the schemes may be configured to the S-SSB transmitting and receiving terminals by using one or more signaling schemes among the signaling schemes exemplified above. The number of consecutive repeated transmissions may be set and operated in a cell-specific, UE-specific, or resource pool-specific (RP)-specific manner.

The structure of S-SSB transmitted in the beam pairing scheme may be designed by modifying or expanding the structure of FIG. 9. In addition, the schemes described in FIGS. 9, 10A, and 10B may be applied, modified, combined, or expanded.

### [Synchronization Reference Selection Scheme]

Table 1 exemplifies the case where only a base station is used as a synchronization reference, and in that case, only whether a UE is located within or outside the coverage of the base station has been described. However, in the 5G NR communication standard, a base station and a global navigation satellite system (GNSS) may be used as a synchronization reference. Therefore, the synchronization signal transmitting terminal may select either GNSS or base station as a synchronization reference. In the GNSS-based or base station (gNB/eNB)-based synchronization acquisition scheme, priorities of synchronization signals may be exemplified as shown in Table 3 below.

TABLE 3

| GNSS-based synchronization | gNB/eNB-based synchronization |
|---|---|
| P0: GNSS | P0′: gNB/eNB |
| P1: UE directly synchronized to | P1′: UE directly synchronized to |
| GNSS | gNB/eNB |
| P2: UE indirectly synchronized | P2′: UE indirectly synchronized to |
| to GNSS | gNB/eNB |
| P3: gNB/eNB | P3′: GNSS |
| P4: UE directly synchronized to | P4′: UE directly synchronized to |
| gNB/eNB | GNSS |
| P5: UE indirectly synchronized | P5′: UE indirectly synchronized to |
| to gNB/eNB | GNSS |
| P6: the remaining UEs have the | P6′: the remaining UEs have the |
| lowest priority. | lowest priority. |

Referring to Table 3, the priorities are exemplified in the scheme using GNSS-based synchronization and the scheme using gNB/eNB-based synchronization. In Table 3, the higher the synchronization signal is listed, the higher its priority may be, and the lower the synchronization signal is listed, the lower its priority may be. For example, when using GNSS-based synchronization, P0 may correspond to a satellite system (GNSS) itself, P1 may correspond to a UE directly synchronized to GNSS, P2 may correspond to a UE indirectly synchronized to GNSS, P3 may correspond to a base station (gNB/eNB), P4 may correspond to a UE directly synchronized to a base station, P5 may correspond to a UE indirectly synchronized to a base station, and P6 may correspond to a UE not included in the above cases. Therefore, P1 may correspond to a UE with a higher priority than P2, and a UE at P6 has the lowest priority.

In addition, in case of using gNB/eNB-based synchronization, P0′ may correspond to a base station (gNB/eNB), P1′ may correspond to a UE directly synchronized to a gNB/eNB, P2′ may correspond to a UE indirectly synchronized to a gNB/eNB, P3′ may correspond to a GNSS, P4′ may correspond to a UE directly synchronized to GNSS, P5′ may correspond to a UE indirectly synchronized to GNSS, and P6′ may correspond to a UE not included in the above cases. Therefore, P1′ may correspond to a UE with a higher priority than P2′, and a UE at P6′ has the lowest priority.

Terminals may attempt to acquire synchronization according to the priorities shown in Table 3. As shown in the example in Table 3, in order to provide the receiving terminal with information on a priority of a transmitted synchronization signal, an SL synchronization signal ID (SL-SSID) and an in-coverage indicator (ICI) may be used. There may be 672 SL-SSIDs configured with combinations of 2 S-PSS sequences and 336 S-SSS sequences. Values from 0 to 671 may be set based on SL-SSID indexes. The ICI may be a value indicated by the S-MIB transmitted through the PSBCH of S-SSB and may be set using a 1-bit in-coverage indication field. In other words, if the synchronization signal transmitting terminal transmitting S-SSB is located within a coverage of a base station (i.e., in-coverage), the ICI may be indicated as ‘True’ or ‘1’, and if it is located outside the coverage (i.e., out-of-coverage), the ICI may be indicated as ‘False’ or ‘0’. In other words, whether the terminal is located within or outside the coverage may be indicated with the 1-bit in-coverage indication field.

A transmitting terminal (TX-UE) that wishes to transmit SL data in an FR2 band may transmit S-SSBs through beam sweeping as illustrated in FIGS. 9, 10A, and 10B described above. A receiving terminal (RX-UE) that needs to receive SL data may obtain information on beams for beam pairing through a process of receiving the S-SSBs. In other words, the terminal receiving data may need to periodically check whether there is a TX-UE to transmit data to itself through S-SSB monitoring.

In the case described above, the terminal (i.e., RX-UE) attempting to receive S-SSB needs to attempt to receive S-SSB(s) transmitted through beam sweeping, so the number of reception attempts may increase. In addition, the terminal (i.e., TX-UE) transmitting S-SSBs may operate as a terminal transmitting synchronization signals even when there is no data to be transmitted. Therefore, the number of receptions attempts by the receiving terminal attempting to receive S-SSB may further increase.

To solve this problem, when transmitting S-SSBs, if there is data that the transmitting terminal wishes to transmit, the transmitting terminal may indicate this. In the present disclosure, for convenience of description, an indicator indicating that there is data to be transmitted is referred to as a ‘data transmit indicator (DTI)’. The DTI may be signaled using a 1-bit field within the S-MIB of PSBCH. Alternatively, the DTI may be indicated by higher layer signaling such as RRC and/or MAC-CE signaling. If indicated using higher layer signaling, the DTI may be indicated by using one or more SL-SSIDs configured as SL-SSID(s) used by terminals that have data to transmit. When indicating that there is data to transmit using the one or more SL-SSIDs among SL-SSIDs, the DTI may be indicated through S-PSS and S-SSS corresponding to the SL-SSID.

In this case, the SL-SSID(s) for DTI indication may be configured by higher layer signaling such as MAC-CE, RRC, S-SIB, and/or S-MIB signaling. In addition, the SL-SSID(s) signaled through higher layer signaling may be configured and operated in a cell-specific or resource pool-specific (RP-specific) manner.

In the following description, for convenience of description, as a DTI setting scheme, the DTI may be indicated as ‘True’ when a terminal with data to transmit transmits the S-SSB, and the DTI may be indicated as ‘False’ when a terminal with no data to transmit transmits the S-SSB. Tables 4 and 5 below provide examples of DTI setting schemes using SL-SSID.

TABLE 4

| Coverage classification | |
|---|---|
| and DTI setting | Available SL-SSIDs |
| In-coverage, DTI = ‘False’ | 0, . . . 300 |
| Out-of coverage, DTI = ‘False’ | 336, . . . 636 |
| DTI = ‘True’ | 301, . . . 335, 636, . . . 671 |

TABLE 5

| Coverage classification | |
|---|---|
| and DTI setting | Available SL-SSIDs |
| In-coverage, DTI = ‘False’ | 0, . . . 300 |
| Out-of coverage, DTI = ‘False’ | 336, . . . 636 |
| In-coverage, DTI = ‘True’ | 301, . . . 335 |
| Out-of coverage, DTI = ‘True’ | 636, . . . 671 |

Tables 4 and 5 show the case of mapping and operating the available SL-SSIDs depending on whether the terminal transmitting the synchronization signal is in-coverage or out-of-coverage and whether the DTI is set to ‘True’ or ‘False’. When using Tables 4 and 5, when the receiving terminal receives an S-SSB and identifies (detects) an SL-SSID thereof, the receiving terminal is able to determine whether a terminal that transmitted the S-SSB is a terminal that wishes to transmit data or a terminal that does not wish to transmit data. In addition, the receiving terminal is able to determine whether the transmitting terminal is an in-coverage terminal or an out-of-coverage terminal by detecting the SL-SSID.

Describing the case of Table 4 as an example, a terminal receiving an SL-SSID index 11 may determine that a terminal transmitting an S-SSB corresponding to the SL-SSID index 11 is an in-coverage terminal and has no data to transmit because the SL-SSID index 11 indicates an in-coverage terminal and a DTI set to ‘False’. As another example in Table 4, a terminal receiving an SL-SSID index 311 may determine that a terminal transmitting an S-SSB corresponding to the SL-SSID index 311 has data to transmit because the SL-SSID index 311 indicates a DTI set to ‘True’.

Describing the case of Table 5 using the same indexes, a terminal receiving an SL-SSID index 11 may determine that a terminal transmitting an S-SSB corresponding to the SL-SSID index 11 is an in-coverage terminal and has no data to transmit because the SL-SSID index 11 indicates an in-coverage terminal and a DTI set to ‘False’. In addition, according to Table 5, a terminal receiving an SL-SSID index 311 may determine that a terminal transmitting an S-SSB corresponding to the SL-SSID index 311 is an in-coverage terminal and has data to transmit because the SL-SSID index 311 indicates an in-coverage terminal and a DTI set to ‘True’.

Tables 4 and 5 described above are merely embodiments according to the present disclosure, and SL-SSID index values may be set differently from the examples above. In other words, the present disclosure may implement various configurations using SL-SSIDs for identifying whether the transmitting terminal is within a coverage of a synchronization source (e.g., GNSS or gNB/eNB) and whether it is a transmitting terminal that wishes to transmit data. Therefore, the two states of the transmitting terminal may be represented using a modified form different from the above-described examples using SL-SSID index values.

When a DTI is indicated, if the synchronization conditions excluding the DTI in Table 3 described above are the same, the receiving terminal may prioritize a synchronization signal from a transmitting terminal with a DTI set to ‘True’. In other words, if the synchronization conditions excluding the DTI are the same, the receiving terminal may synchronize with the transmitting terminal whose DTI is set to True.

This may be exemplified as shown in Table 6 below.

TABLE 6

| GNSS-based synchronization | gNB/eNB-based synchronization |
|---|---|
| P0: GNSS | P0′: gNB/eNB |
| P1: UE directly synchronized to | P1′: UE directly synchronized to |
| GNSS, DTI = ‘True’ | gNB/eNB, DTI = ‘True’ |
| P2: UE directly synchronized to | P2′: UE directly synchronized to |
| GNSS, DTI = ‘False’ | gNB/eNB, DTI = ‘False’ |
| P3: UE indirectly synchronized to | P3′: UE indirectly synchronized to |
| GNSS, DTI = ‘True’ | gNB/eNB, DTI = ‘True’ |
| P4: UE indirectly synchronized to | P4′: UE indirectly synchronized to |
| GNSS, DTI = ‘False’ | gNB/eNB, DTI = ‘False’ |
| P5: gNB/eNB | P5′: GNSS |
| P6: UE directly synchronized to | P6′: UE directly synchronized to |
| gNB/eNB, DTI = ‘True’ | GNSS, DTI = ‘True’ |
| P7: UE directly synchronized to | P7′: UE directly synchronized to |
| gNB/eNB, DTI = ‘False’ | GNSS |
| P8: UE indirectly synchronized to | P8′: UE indirectly synchronized to |
| gNB/eNB, DTI = ‘True’ | GNSS, DTI = ‘True’ |
| P9: UE indirectly synchronized to | P9′: UE indirectly synchronized to |
| gNB/eNB, DTI = ‘False’ | GNSS, DTI = ‘False’ |
| P10: the remaining UEs have the | P10′: the remaining UEs have the |
| lowest priority, DTI = ‘True’ | lowest priority, DTI = ‘True’ |
| P11: the remaining UEs have the | P11′: the remaining UEs have the |
| lowest priority, DTI = ‘False’ | lowest priority, DTI = ‘False’ |

Describing Table 6 in more detail, priorities in GNSS-based synchronization may be understood as follows.

P0 may correspond to the GNSS itself, as previously described in Table 3. P1 may correspond to a case where a UE that transmitted the SL-SSID is a UE directly synchronized to GNSS and a DTI is set to ‘True’. P2 may correspond to a case where a UE that transmitted the SL-SSID is a UE directly synchronized to GNSS and a DTI is set to ‘False’. P3 may correspond to a case where a UE that transmitted the SL-SSID is a UE indirectly synchronized to GNSS and a DTI is set to ‘True’. P4 may correspond to a case where a UE that transmitted the SL-SSID is a UE indirectly synchronized to GNSS and a DTI is set to ‘False’. P5 may correspond to a base station (gNB/eNB) itself. P6 may correspond to a case where a UE that transmitted the SL-SSID is a UE directly synchronized to the gNB/eNB and a DTI is set to ‘True’. P7 may correspond to a case where a UE that transmitted the SL-SSID is a UE directly synchronized to the gNB/eNB and a DTI is set to ‘False’. P8 may correspond to a case where a UE that transmitted the SL-SSID is a UE indirectly synchronized to the gNB/eNB and a DTI is set to ‘True’. P9 correspond to be a case where a UE that transmitted the SL-SSID is a UE indirectly synchronized to the gNB/eNB and a DTI is set to ‘False’. P10 may correspond to a case where a UE that transmitted the SL-SSID does not correspond to the above cases (P1-P9) and a DTI of the UE is set to ‘True’. Lastly, P11 may correspond to a case where a UE that transmitted the SL-SSID does not correspond to the above cases (P1-P9) and a DTI of the UE is set to ‘False’.

In addition, describing gNB/eNB-based synchronization, priorities may be determined as follows. First, P0′ may correspond to a gNB/eNB itself, which is the same case as Table 3 described above. P1′ may correspond to a case where a UE that transmitted the SL-SSID is directly synchronized to a gNB/eNB and a DTI is set to ‘True’. P2′ may correspond to a case where a UE that transmitted the SL-SSID is a UE directly synchronized to a gNB/eNB and a DTI is set to ‘False’. P3′ may correspond to a case where a UE that transmitted the SL-SSID is a UE indirectly synchronized to a gNB/eNB and a DTI is set to ‘True’. P4′ may correspond to a case where a UE that transmitted the SL-SSID is a UE indirectly synchronized to a gNB/eNB and a DTI is set to ‘False’. P5′ may correspond to a case where the GNSS itself is used as a synchronization source. P6′ may correspond to a case where a UE that transmitted the SL-SSID is a UE directly synchronized to GNSS and a DTI is set to ‘True’. P7^{T} may correspond to a case where a UE that transmitted the SL-SSID is directly synchronized to GNSS. P8′ may correspond to a case that a UE that transmitted the SL-SSID is a UE indirectly synchronized to GNS and a DTI is set to ‘True’. P9′ may correspond to a case where a UE that transmitted the SL-SSID is a UE indirectly synchronized to GNSS and a DTI is set to ‘False’. P10′ may correspond to a case where a UE that transmitted the SL-SSID does not correspond to the above P1^{t} to P9′ and a DTI is set to ‘True’. P11^{t} may correspond to a case where a UE that transmitted the SL-SSID does not correspond to the above P1^{t} to P9′ and a DTI is set to ‘False’.

As described above, in the present disclosure, priorities may be newly set based on DTI.

[Decision on Whether to Perform Initial Beam Process after S-SSB Transmission]

In the present disclosure, it may be determined based on the schemes described above whether to perform an initial beam process, for example, initial beam pairing, between the transmitting UE (TX-UE) and the receiving UE (RX-UE).

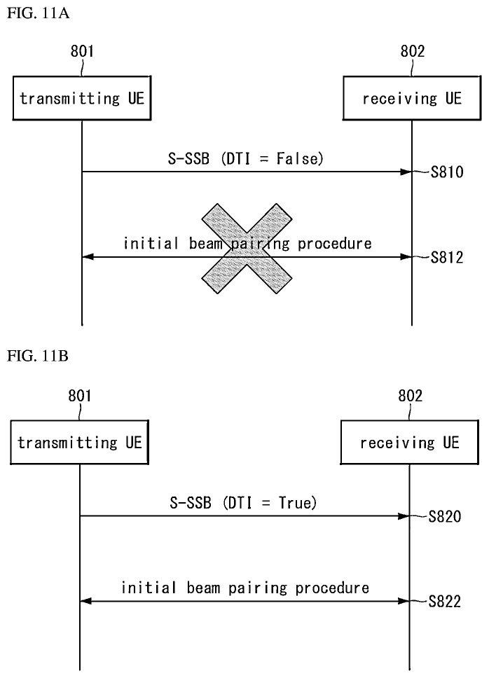

FIG. 11A is a signal flow diagram for a case where an initial beam pairing procedure is not performed based on S-SSBs according to an embodiment of the present disclosure. FIG. 11B is a signal flow diagram an initial beam pairing procedure is performed based on S-SSBs according to an embodiment of the present disclosure.

A transmitting UE 801 illustrated in FIGS. 11A and 11B may be a UE that transmits S-SSB, and a receiving UE 802 may be a UE that receives S-SSB. In addition, the transmitting UE 801 may be classified into a case where there is data to transmit (FIG. 11A) and a case where there is no data to transmit (FIG. 11B). Hereinafter, operations of the transmitting UE 801 and operations of the receiving UE 802 according to the present disclosure are described.

As shown in FIG. 11A, the transmitting UE 801 may transmit S-SSBs to the receiving UE 802 in step S810. Since the transmitting UE 801 is a UE with no data to transmit, a DTI therefor may be set to ‘False’. The DTI may be signaled using one of various schemes previously exemplified. For example, the DTI may be indicated using a 1-bit field within the S-MIB of PSBCH. Alternatively, the DTI may be indicated by higher layer signaling such as RRC and/or MAC-CE signaling, and an SL-SSID may be transmitted based on configuration by the higher layer signaling. In particular, in the case of FIG. 11A, SL-SSID(s) used by terminals that do not have data to transmit may be set and transmitted. When using the SL-SSID(s), whether or not data to transmit exists may be notified using the form exemplified in Table 4 or Table 5 described above or a modified form of Table 4 or 5.

Therefore, the receiving UE 802 may not proceed with an initial beam pairing procedure as illustrated in step S812. In other words, the receiving terminal 802 may not perform an initial beam pairing procedure with the transmitting terminal 801. The initial beam pairing procedure may refer to a process of configuring a pair of transmission and reception beams between the transmitting UE 801 that transmitted the S-SSB and the receiving UE 802 that received the S-SSB. If the initial beam pairing procedure is performed, one or more signaling procedures may be performed between the transmitting UE 801 and the receiving UE 802.

As shown in FIG. 11B, the transmitting UE 801 may transmit S-SSBs to the receiving UE 802 in step S820. Since the transmitting UE 801 is a UE with data to transmit, a DTI therefor may be set to ‘True’. The DTI may be signaled using one of various schemes previously exemplified. For example, the DTI may be indicated using a 1-bit field within the S-MIB of PSBCH. Alternatively, the DTI may be indicated by higher layer signaling such as RRC and/or MAC-CE signaling, and an SL-SSID may be transmitted based on configuration by the higher layer signaling. In particular, in the case of FIG. 11B, SL-SSID(s) used by terminals that have data to transmit may be set and transmitted. When using the SL-SSID(s), whether or not data to transmit exists may be notified using the form exemplified in Table 4 or Table 5 described above or a modified form of Table 4 or 5.

Accordingly, the receiving UE 802 may proceed with an initial beam pairing procedure as illustrated in step S822. In other words, the receiving terminal 802 may perform an initial beam pairing procedure with the transmitting terminal 801. Although not illustrated in FIG. 11B, it may be confirmed whether data transmitted by the transmitting UE 801 is transmitted to the receiving UE 802 through the initial beam pairing procedure and a signaling procedure. For example, when the transmitting UE 801 wishes to transmit data, it may transmit a destination identifier (ID) or a receiving UE identifier (RX-UE ID) of the data to be transmitted. Accordingly, the receiving UE 802 may check whether the destination ID or the receiving UE identifier (RX-UE ID) of the data to be transmitted by the transmitting UE 801 indicates itself. The receiving UE 802 may confirm this through a procedure of checking the corresponding signal.

In addition, the initial beam pairing procedure may refer to a process of configuring a pair of transmission and reception beams between the transmitting UE 801 that transmitted the S-SSB and the receiving UE 802 that received the S-SSB. Therefore, when the initial beam pairing procedure is performed, one or more signaling procedures may be performed between the transmitting UE 801 and the receiving UE 802.

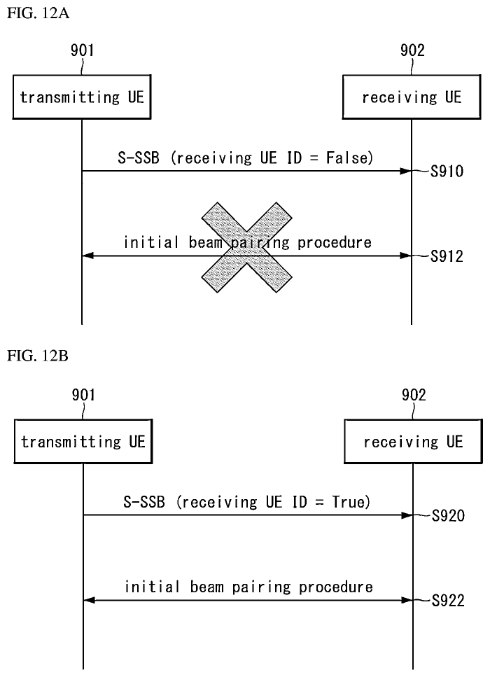

FIG. 12A is a signal flow diagram for a case where an initial beam pairing procedure is not performed based on S-SSBs according to another embodiment of the present disclosure. FIG. 12B is a signal flow diagram an initial beam pairing procedure is performed based on S-SSBs according to another embodiment of the present disclosure.

A transmitting UE 901 illustrated in FIGS. 12A and 12B may be a UE that transmits S-SSB, and a receiving UE 902 illustrated in FIGS. 12A and 12B may be a UE that receives S-SSB. In addition, the transmitting UE 901 may have data to transmit. Therefore, FIGS. 12A and 12B illustrate operations for a case where the transmitting UE with data to transmit transmits destination ID(s) or receiving UE ID(s) of the data through the S-SSB. Each of the destination ID(s) or receiving UE ID(s) may be a part of or an entire ID for identification of each receiving UE. Alternatively, each of the destination ID(s) or receiving UE ID(s) may be a part of or an entire ID assigned by matching a specific service type, SL communication scheme, configuration, environment, service target frequency, and/or the like, or may be a part of or an entire ID temporarily generated for a specific purpose when initial ID exchange between the transmitting and receiving terminals is not possible. This ID may be an ID transmitted by higher layer signaling such as MAC-CE or RRC.

As shown in FIG. 12A, the transmitting UE 901 may transmit S-SSB to the receiving UE 902 in step S910. The S-SSB may include ID(s) corresponding to at least one of the schemes described above. The receiving UE 902 may receive the S-SSB in step S910 and identify the ID(s) included in the S-SSB. FIG. 12A may correspond to a case where the ID(s) included in the S-SSB transmitted by the transmitting UE 901 does not include the ID of the receiving UE 902, and this scenario may be depicted in FIG. 12A by expressing the receiving UE ID as ‘False’. In FIGS. 12A and 12B, the receiving UE ID is expressed as ‘False’ or ‘True’ for convenience of description, and it may express whether the receiving UE ID included in the S-SSB matches to the ID of the receiving UE 902. For example, if the received UE ID is expressed as ‘False’, it may indicate that the received UE ID(s) transmitted through the S-SSB and the ID of the RX-UE 902 that received the S-SSB do not match. On the other hand, if the receiving UE ID is expressed as ‘True’, it may indicate that the receiving UE ID(s) transmitted through the S-SSB and the ID of the receiving UE 902 that received the S-SSB match.

Step S910 illustrates a case where the ID of the receiving UE 902 is different from the ID included in the S-SSB and it is expressed as ‘False’ in FIG. 12A. Therefore, the receiving UE 902 may not proceed with an initial beam pairing procedure as illustrated in step S912. In other words, the receiving terminal 902 may not perform an initial beam pairing procedure with the transmitting terminal 901. The initial beam pairing procedure may refer to a process of configuring a pair of transmission and reception beams between the transmitting UE 801 that transmitted the S-SSB and the receiving UE 802 that received the S-SSB, as described in FIGS. 11A and 11B. In FIG. 12A, since the transmitting UE 901 has data to transmit but the data is not data that the receiving UE 902 is to receive, the receiving UE 902 may not perform an initial beam pairing procedure with the transmitting UE 901.

As shown in FIG. 12B, the transmitting UE 901 may transmit S-SSB to the receiving UE 902 in step S920. The S-SSB may include ID(s) corresponding to at least one of the schemes described above. The receiving UE 902 may receive the S-SSB in step S920 and identify the ID(s) included in the S-SSB. FIG. 12B may correspond to a case where the ID of the receiving UE 902 exists in the ID(s) included in the S-SSB transmitted by the transmitting UE 901, and this scenario may be depicted in FIG. 12B by expressing the receiving UE ID as ‘True’.

Accordingly, the receiving UE 902 may proceed with an initial beam pairing procedure as illustrated in step S922. In other words, the receiving terminal 902 may perform an initial beam pairing procedure with the transmitting terminal 901. As described above, the initial beam pairing procedure may refer to a process of configuring a pair of transmission and reception beams between the transmitting UE 801 that transmitted the S-SSB and the receiving UE 802 that received the S-SSB. Therefore, when the initial beam pairing procedure is performed, one or more signaling procedures may be performed between the transmitting UE 901 and the receiving UE 902.

The receiving UE ID(s) described in FIG. 12B may be transmitted together with the DTI described previously in Tables 4 and 5 and FIGS. 11A and 11B. In other words, the DTI and receiving UE ID(s) may be transmitted together through the S-SSB. When the DTI and receiving UE ID(s) are transmitted together through the S-SSB, the receiving UE that received the S-SSB and the UE that transmitted the S-SSB may operate in the manner shown in Table 7 below.

TABLE 7

| DTI, and whether RX-UE ID | Operations of transmitting/receiving |
|---|---|
| matches | terminals |
| DTI = True, RX-UE ID = True | Initial beam pairing process/signaling |
| DTI = True, RX-UE ID = False | Broadcast, No initial beam pairing |
| DTI = False, RX-UE ID = True | Paging, No initial beam pairing |
| DTI = False, RX-UE ID = False | Synchronization, No initial beam |
| | pairing |

As exemplified in Table 7 above, if the DTI is set to ‘True’ and whether the receiving UE ID matches is set to ‘True’ (i.e., meaning that the receiving UE is intended to receive data to be transmitted by the transmitting UE), the transmitting UE may transmit the corresponding information by including it in the S-SSB. Therefore, the receiving UE may proceed with an initial beam pairing procedure/signaling with the transmitting UE if the DTI transmitted through the S-SSB is set to ‘True’ and whether the receiving UE ID matches is set to ‘True’.

If the DTI is set to ‘True’ and whether the receiving UE ID matches is set to ‘False’, the transmitting UE may perform broadcasting, and the receiving UE may not perform additional initial beam pairing. In other words, the above-described scheme may be possible when the transmitting UE has a special purpose such as public safety or has data to broadcast. The purpose of the above-described operation is to provide synchronization information to surrounding terminals that have not acquired synchronization before the transmitting UE performs broadcasting, and to transmit data efficiently by broadcasting and transmitting the data in the beam sweeping scheme.

If the DTI is set to ‘False’ and whether the receiving UE ID matches is set to ‘True’, the transmitting UE may perform paging, and the receiving UE may wake up and prepare for SL communication. In other words, in this case, the receiving UE IDs included in the S-SSB may correspond to terminals subject to paging, and the S-SSB transmitted by the transmitting UE may be used for synchronization correction with the corresponding terminals.

Lastly, if the DTI is set to ‘False’ and whether the receiving UE ID matches is also set to ‘False’, the transmitting UE may be a terminal that simply transmitted a synchronization signal and may be a UE that delivers synchronization information to its neighbors. Accordingly, the receiving UE may also only obtain the synchronization information from the transmitting UE.

The operations of FIGS. 11A and 11B described above, the operations of FIGS. 12A and 12B, and additional methods using Table 7 may be expanded and applied to a process in which a plurality of receiving UEs operate by receiving the S-SSB. In addition, it may be possible to simply apply the operations of FIGS. 11A and 11B, the operations of FIGS. 12A and 12B, and the operations described in Table 7. In addition, a modification or a combination of the operations of FIGS. 11A and 11B, the operations of FIGS. 12A and 12B, and the operations described in Table 7 may be possible. For example, it may be possible to apply and operate by defining operations of the transmitting/receiving UEs that are configurable according to whether the receiving UE ID matches as described in Table 7.

### [S-SSB Transmission Triggering Scheme]

There are the following two triggering schemes for an SL terminal (UE) to transmit a synchronization signal.

1) A specific terminal may be configured by the network to transmit a synchronization signal as a synchronization reference (SyncRef) UE

2) A UE itself may measure reference signal received power (RSRP), and the like based on a signal associated with a synchronization signal, such as PBCH, PSBCH, or DM-RS of each PBCH and PSBCH, and based on a specific threshold configured by the network, determine whether to transmit a synchronization signal as a SyncRef UE.

When performing SL communication in an FR2 band, the transmitting UE and the receiving UE may need to mutually obtain beam information for beam pairing.

When this beam information acquisition process is performed by the S-SSB as illustrated in FIG. 9 and FIG. 10A or 10B, the transmitting UE may need to necessarily transmit the synchronization signal. Therefore, the UE may additionally configure and operate the following three schemes in addition to the above two schemes as triggering schemes for synchronization signal transmission.

Addition 1) If data to be transmitted to UE(s) among UEs with which a transmitting UE attempts SL communication occurs, the transmitting UE may transmit a synchronization signal as a SyncRef UE.

Addition 2) If data to be transmitted to UE(s) among UEs with which a transmitting UE attempts SL communication in an FR2 band occurs, the transmitting UE may transmit a synchronization signal as a SyncRef UE.

Addition 3) If data to be transmitted to UE(s) among UEs for which beam sweeping-based S-SSB transmission is performed, a transmitting UE may transmit a synchronization signal as a SyncRef UE.

A specific one scheme of the addition 1) to addition 3) may be used as a triggering scheme for synchronization signal transmission, or two or more thereof may be used.

The operations of the method according to the embodiments of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include machine language codes created by a compiler and high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some embodiments, a programmable logic device such as a field-programmable gate array may be used to perform some or all of functions of the methods described herein. In some embodiments, the field-programmable gate array may be operated with a microprocessor to perform one of the methods described herein. In general, the methods may be performed by a certain hardware device.

The description of the disclosure is merely exemplary in nature and, thus, variations that do not depart from the substance of the disclosure are intended to be within the scope of the disclosure. Such variations should not be regarded as a departure from the spirit and scope of the disclosure. Thus, it should be understood by those of ordinary skill in the art that various changes in form and details may be made without departing from the spirit and scope as defined by the following claims.

What is claimed is:

1. A method of using a transmitting user equipment (UE), the method comprising:
identifying whether data to be transmitted by the transmitting UE exists;
determining a sidelink synchronization signal block (S-SSB) based on whether the data to be transmitted exists; and
transmitting the determined S-SSB through each of transmission beams of the transmitting UE based on a beam sweeping scheme.

2. The method according to claim 1, wherein a relationship between whether the data to be transmitted exists and the S-SSB is preconfigured through higher layer signaling.

3. The method according to claim 2, wherein the higher layer signaling includes at least one of medium access control (MAC) control element (CE) or radio resource control (RRC) signaling.

4. The method according to claim 1, wherein the determined S-SSB includes information on a synchronization source of the transmitting UE and information indicating whether the synchronization source is in-coverage or out-of-coverage.

5. The method according to claim 1, wherein the determined S-SSB includes information on an identifier of a UE to receive the data to be transmitted.

6. The method according to claim 1, further comprising:
identifying a number of times the determined S-SSB needs to be transmitted within a transmission period of the S-SSB and a number of the transmission beams; and
in response to the number of the transmission beams being smaller than the number of times the determined S-SSB needs to be transmitted, transmitting the determined S-SSB by repeating at least one of the transmission beams.

7. The method according to claim 6, wherein the number of times the determined S-SSB needs to be transmitted is preconfigured through higher layer signaling.

8. The method according to claim 6, wherein a number of repeated transmissions and a repeated transmission scheme for the determined S-SSB are preconfigured using at least one of MAC CE, RRC signaling, system information block (SIB), or master information block (MIB).

9. A transmitting user equipment (UE) comprising a processor, wherein the processor is configured to cause the transmitting UE to:
identify whether data to be transmitted exists;
determine a sidelink synchronization signal block (S-SSB) based on whether the data to be transmitted exists; and
transmit the determined S-SSB through each of transmission beams of the transmitting UE based on a beam sweeping scheme.

10. The transmitting UE according to claim 9, wherein a relationship between whether the data to be transmitted exists and the S-SSB is preconfigured through higher layer signaling.

11. The transmitting UE according to claim 10, wherein the higher layer signaling includes at least one of medium access control (MAC) control element (CE) or radio resource control (RRC) signaling.

12. The transmitting UE according to claim 9, wherein the determined S-SSB includes information on a synchronization source of the transmitting UE and information indicating whether the synchronization source is in-coverage or out-of-coverage.

13. The transmitting UE according to claim 9, wherein the determined S-SSB includes information on an identifier of a UE to receive the data to be transmitted.

14. The transmitting UE according to claim 9, wherein the processor is further configured to cause the transmitting UE to:
identify a number of times the determined S-SSB needs to be transmitted within a transmission period of the S-SSB and a number of the transmission beams; and
in response to the number of the transmission beams being smaller than the number of times the determined S-SSB needs to be transmitted, transmit the determined S-SSB by repeating at least one of the transmission beams.

15. The transmitting UE according to claim 14, wherein the number of times the determined S-SSB needs to be transmitted is preconfigured through higher layer signaling.

16. The transmitting UE according to claim 14, wherein a number of repeated transmissions and a repeated transmission scheme for the determined S-SSB are preconfigured using at least one of MAC CE, RRC signaling, system information block (SIB), or master information block (MIB).

17. A method of use for a receiving user equipment (UE), the method comprising:
receiving, through higher layer signaling, configuration information of a relationship between whether data to be transmitted exists and a sidelink synchronization signal block (S-SSB);
receiving, from a transmitting UE, an S-SSB including information on whether data to be transmitted exists, in a transmission period of the S-SSB; and
identifying whether the data to be transmitted by the transmitting UE exists based on the received S-SSB.

18. The method according to claim 17, further comprising:
in response to identifying that the data to be transmitted by the transmitting UE exists, starting an initial beam pairing procedure with the transmitting UE.

19. The method according to claim 17, further comprising:
in response to identifying that the data to be transmitted by the transmitting UE exists, comparing an identifier of a destination UE included in the received S-SSB and an identifier of the receiving UE; and
in response to the identifier of the destination UE being equal to the identifier of the receiving UE, starting an initial beam pairing procedure with the transmitting UE.

20. The method according to claim 17, wherein the higher layer signaling includes at least one of medium access control (MAC) control element (CE) or radio resource control (RRC) signaling.
